(19) United States
(12) Patent Application Publication
(10) Pub. No.: US 2015/0342168 A1
(43) Pub. Date: Dec. 3, 2015

(54) Fishing Equipment Storage Device

(71) Applicant: Jack Helms, Whitmore Lake, MI (US)

(72) Inventor: Jack Helms, Whitmore Lake, MI (US)

(21) Appl. No.: 14/591,359

(22) Filed: Jan. 7, 2015

Related U.S. Application Data
(60) Provisional application No. 62/004,563, filed on May 29, 2014.

(51) Int. Cl. A01K 97/10; A01K 97/04

(52) U.S. Cl. CPC A01K 97/10; A01K 97/04

(57) ABSTRACT

A fishing equipment storage device that can be disposed on a support surface, such as an ice fishing sled. The fishing equipment storage device includes an elongated panel having one or more fishing rod holders thereon, wherein each fishing rod holder has a tubular construction. The fishing rod holders store fishing rods in an upright, vertical orientation. The elongated panel further includes one or more storage compartments thereon for holding other fishing equipment such as bait, lines, and lures, and the like. The upper end of the elongated panel includes a U-shaped lip thereon that can be disposed over the upper end of a sidewall of an ice fishing sled. The U-shaped lip includes hand-screws or similar fasteners thereon for removably securing the device to the ice fishing sled.

### CROSS REFERENCE TO RELATED APPLICATION

This application claims the benefit of U.S. Provisional Application No. 62/004,563 filed on May 29, 2014. The above identified patent application is herein incorporated by reference in its entirety to provide continuity of disclosure.

### BACKGROUND OF THE INVENTION

1. Field of the Invention

The present invention relates to fishing equipment storage devices. More specifically, the present invention provides a fishing equipment store device removably securable to an ice fishing sled that allows a user to organize and store various fishing equipment to protect the equipment from breakage or damage during travel. The device includes an elongated panel having a U-shaped lip at an upper end thereof that can be disposed over a sidewall of the ice fishing sled. The U-shaped panel includes one or more fishing rod holders thereon and one or more storage compartments.

Various equipment is required for ice fishing and an ice fisherman must transport his or her equipment to a fishing location. Fishermen often require one or more fishing rods, various types of bait and lures, a stool or chair, food and clothing, among various other items. Accordingly, it can be cumbersome and inconvenient for fishermen to carry their equipment by hand, and many fisherman use an ice fishing sled to more easily transport these various items. Equipment can be placed in the sled and the user can then drag the sled across the snow or ice to the location where he or she wants to ice fish.

However, ice fishing sleds provide only an open interior volume in which the fisherman's equipment can be placed, and do not have dividers or compartments for organizing the equipment. Without compartments and fishing rod holders, the equipment is often placed in the sled in an unorganized, haphazard manner. As a result, equipment, particularly the fishing rods, can become broken or damaged during travel from equipment shifting around inside of the sled. Therefore, a device that helps a user to store and organize fishing equipment while it is transported on an ice fishing sled is desired.

2. Description of the Prior Art

Devices have been disclosed in the prior art that relate to fishing equipment storage devices. These include devices that have been patented and published in patent application publications. These devices generally relate to fishing rod storage devices for holding and securing one or more fishing rods. The following is a list of devices deemed most relevant to the present disclosure, which are herein described for the purposes of highlighting and differentiating the unique aspects of the present invention, and further highlighting the drawbacks existing in the prior art.

One such device, U.S. Pat. No. 7,322,149 to Quintero discloses a device for holding one or more fishing rods and reels for storage. The device comprises a rectangular casing having indentations in which a portion of a fishing rod can be positioned, and further having a clamp for securing the device to the side edge of a boat. The cover includes a mesh portion that is adapted to cover the rods placed within the casing. While Quintero discloses a fishing rod holding device, the device does not include an elongated panel having tubular fishing rod holders thereon, a storage compartment, and a U-shaped upper lip. Quintero discloses only a device for storing fishing rods and does not provide storage for additional fishing equipment.

Another device, U.S. Pat. No. 5,435,473 to Larkum discloses a fishing rod holder having vertical tubes into which the handle portion of a fishing rod can be positioned. A slot extends from an upper portion of each tube that is adapted to receive the post of a fishing reel. A horizontal crossbar passes through holes in the holders to prevent removal of the fishing rods. The crossbar can be secured by means of a padlock. Thus, Larkum discloses a fishing rod holder having a locking mechanism, and does not disclose a fishing equipment storage device for storing additional items and that can be secured to an ice fishing sled.

U.S. Pat. No. 7,219,464 to Kujawa discloses a locking storage system for fishing rods. The device includes a base, a sliding lock panel, and a plurality of rod collars. Openings are formed through the base and a rod collar is positioned therein that is sized to receive the end of a fishing rod. The sliding lock panel captures the reel pedestal of a fishing rod and is secured to the base by means of a padlock. Thus, Kujawa discloses a fishing rod holder with a locking mechanism, and does not disclose a device for holding other fishing equipment or that can be secured to an ice fishing sled.

U.S. Published Patent Application Number 2002/0020644 to Belanger discloses a fishing box having compartments for storing fishing gear. The box includes releasable attachments for releasably attaching a number of box compartments to one another in order to form an integral fishing box assembly. Belanger does not disclose a fishing equipment storage device securable to an ice fishing sled, and does not disclose tubular fishing rod holders for storing fishing rods in a vertical orientation.

U.S. Pat. No. 6,530,170 to Sweeney discloses a fishing pole and reel locking assembly. The device comprises a pole holding rack and a reel cover that can be mounted on a wall. The reel cover can be locked by means of a padlock so as to secure the fishing poles in the pole holding rack. Thus, Sweeney fails to disclose a fishing equipment storage device for holding fishing rods and other equipment that is securable to an ice fishing sled.

These prior art devices have several known drawbacks. Devices in the prior art generally relate to fishing rod holding devices. Such devices include locking mechanisms for further securing the fishing rods therein. These devices, however, do not provide additional storage compartments for storing other fishing equipment, such as bait and lure. Further, the devices in the prior art are not attachable to an ice fishing sled. The present invention provides an elongated panel having a U-shaped lip at an upper end thereof that can be disposed on a sidewall of an ice fishing sled. The elongated panel includes fishing rod holders and at least one storage compartment thereon.

In light of the devices disclosed in the prior art, it is submitted that the present invention substantially diverges in design elements from the prior art and consequently it is clear that there is a need in the art for an improvement to existing fishing equipment holding devices. In this regard the instant invention substantially fulfills these needs.

### SUMMARY OF THE INVENTION

In view of the foregoing disadvantages inherent in the known types of fishing equipment holding devices now present in the prior art, the present invention provides a new fishing equipment holding device wherein the same can be utilized for providing convenience for the user when storing and organizing fishing rods and other equipment during transportation using an ice fishing sled.

It is therefore an object of the present invention to provide a new and improved fishing equipment storage device that has all of the advantages of the prior art and none of the disadvantages.

It is another object of the present invention to provide a fishing equipment storage device that is removably securable to an ice fishing sled.

Another object of the present invention is to provide a fishing equipment storage device having one or more tubular fishing rod holders thereon adapted to hold a fishing rod in a vertical orientation.

Yet another object of the present invention is to provide a fishing equipment storage device have one or more storage compartments for storing additional fishing equipment.

Another object of the present invention is to provide a fishing equipment storage device having a U-shaped upper lip adapted to be disposed over a sidewall of an ice fishing sled.

Yet another object of the present invention is to provide a fishing equipment storage device that may be readily fabricated from materials that permit relative economy and are commensurate with durability.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a front perspective view of an embodiment of the fishing equipment storage device of the present invention.

FIG. 2 shows a perspective view of an embodiment of the fishing equipment storage device as positioned on an ice fishing sled.

FIG. 3 shows a rear perspective view of an embodiment of the fishing equipment storage device of the present invention.

FIG. 4 shows a cross sectional view of an embodiment of the fishing equipment storage device installed on an ice fishing sled.

### DETAILED DESCRIPTION OF THE INVENTION

Reference is made herein to the attached drawings. Like reference numerals are used throughout the drawings to depict like or similar elements of the fishing equipment storage device. For the purposes of presenting a brief and clear description of the present invention, the preferred embodiment will be discussed as used for storing fishing rods and other fishing equipment while transporting the same using an ice fishing sled or other similar vehicle. The figures are intended for representative purposes only and should not be considered to be limiting in any respect.

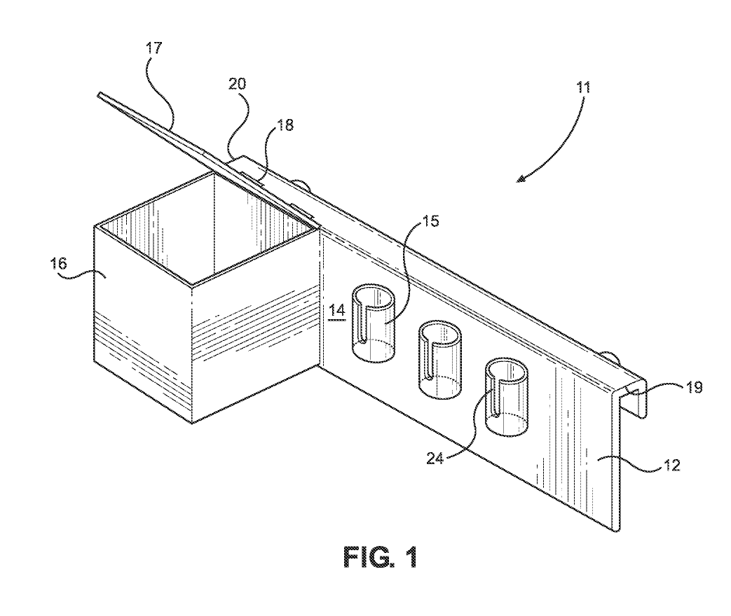

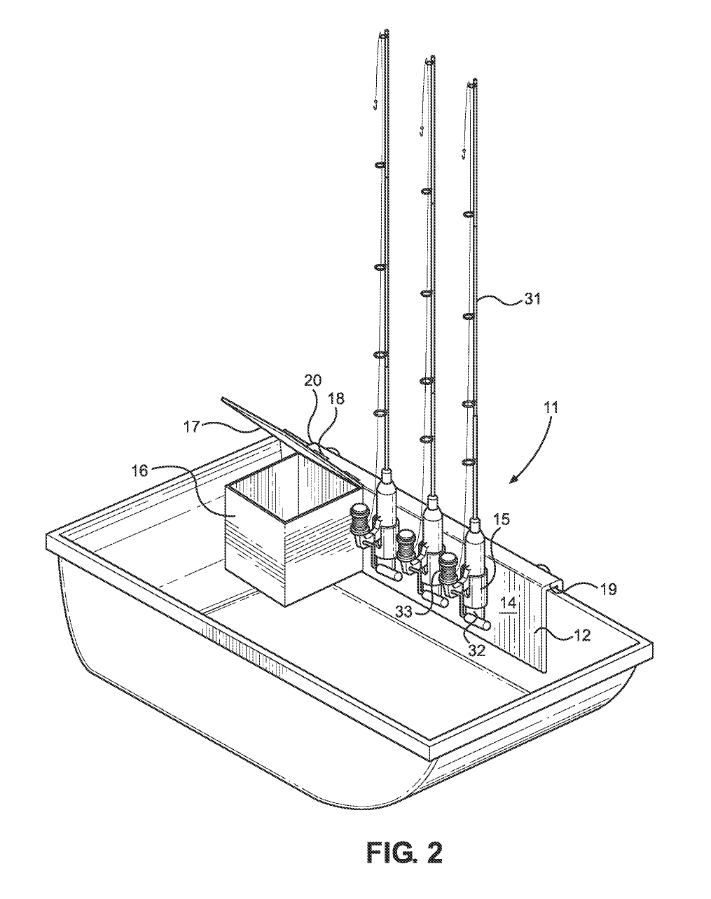

Referring now to FIGS. 1 and 2, there is shown a front perspective view of an embodiment of the fishing equipment storage device of the present invention and a view of an embodiment of the fishing equipment storage device as positioned on an ice fishing sled. The fishing equipment storage device 11 comprises an elongated panel 12 disposed in a vertical orientation and having a first end 19 and a second end 20. The panel 12 is preferably substantially rectangular. The panel 12 comprises a flat surface 14 on which one or more fishing rod holders 15 are positioned, and on which at least one storage compartment 16 is positioned. The upper end of the panel 12 includes a U-shaped lip that is adapted to be disposed over the upper edge of a sidewall of an ice fishing sled, or other similar support surface.

One or more fishing rod holders 15 are permanently affixed to the flat surface 14 of the panel 12. The fishing rod holders 15 are disposed in a vertical orientation so that a fishing rod 31 placed therein is stored in a vertical orientation. The fishing rod holders 15 are arranged side-by-side and are separated at a fixed interval. The fishing rod holders 15 are tubular in configuration and have a hollow interior, an open upper end, and an open lower end. The fishing rod holders 15 further include a channel 23 on a front end thereof that extends from the upper end of the holder 15 towards the bottom end thereof. The channel 23 does not extend entirely from the upper end to the bottom end. Thus, a fishing rod 31 can be positioned with a fishing rod holder 15 such that the handle 32 extends through the bottom end of the holder 15, the reel 33 extends outward from the holder 15 through the channel 23, and the rod 31 extends through the upper end of the holder 15.

At least one storage compartment 16 is disposed on the flat surface 14 of the panel 12. The storage compartment 16 comprises a bottom wall, sidewalls, and an open upper end, defining an interior volume in which various items can be stored. The interior volume may be further divided into smaller compartments to store and organize various items therein. A sidewall of the storage container is placed flush against the panel 12 and is secured thereto using any suitable fasteners, such as screws, bolts, or adhesives among others. The upper end of the storage compartment 16 is level with the upper end of the panel 12. The upper end of the storage compartment 16 includes a lid 17 pivotally attached thereto via a hinge 18. The lid 17 can be used to seal the compartment 16 and can be maintained in a closed position via a latch or locking mechanism, such as a magnetic closure.

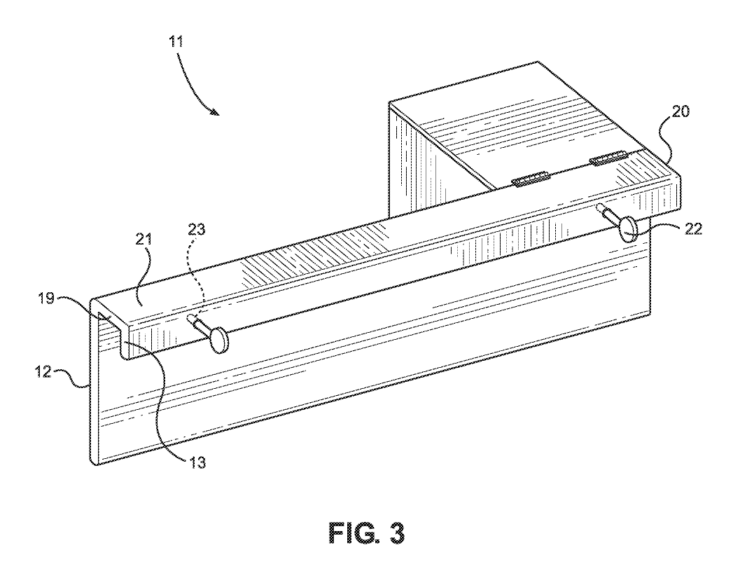

Referring now to FIG. 3, there is shown a rear perspective view of an embodiment of the fishing equipment storage device of the present invention. The upper end of the panel 12 includes a U-shaped lip thereon. The U-shaped lip includes a first section 21 that extends perpendicular to the panel 12 and a second section 13 that turns downward and is parallel to the panel 12. The U-shaped lip is adapted to be positioned over the upper edge of a sidewall of an ice fishing sled, or other similar support surface. In this way, the device can be removably secured to the sidewall of the ice fishing sled.

The U-shaped lip further includes one or more fasteners, such as thumbscrews, thereon for securing the fishing equipment storage device 11 to a desired portion of the ice fishing sled. In the illustrated embodiment, the second section 13 of the device includes thumbscrews having a knob 22 and a rod 23. The rod 23 extends through the second section 13 and toward the elongated panel 12. Thus, the thumbscrew can be adjusted until the rod 23 contacts the sled sidewall, frictionally securing the fishing equipment storage device 11 in place.

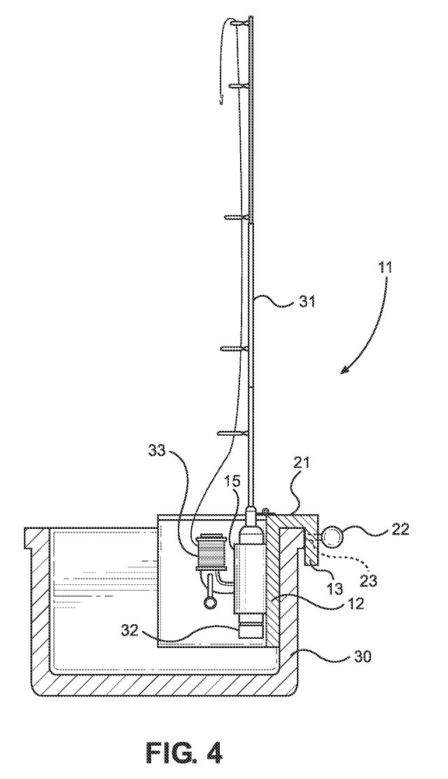

Referring now to FIG. 4, there is shown a cross sectional view of an embodiment of the fishing equipment storage device installed on an ice fishing sled. The panel 12 rests flush against the interior of a sidewall of the ice fishing sled 30. The upper end of the elongated panel 12 includes a U-shaped lip that can be disposed over the upper edge of the sidewall of the ice fishing sled 30. The first section 21 of the U-shaped lip extends over the top of the sidewall, and the second section 13 extends downward from the first section 21 and along the exterior of the sidewall of the ice fishing sled 30. In this way, the fishing equipment storage device can be disposed on the sidewall of an ice fishing sled. A fastener, such as a thumbscrew having a knob 22 and rod 23, extends through the second section 13 and can be adjusted so that the rod 23 engages the exterior of the sidewall of the ice fishing sled in order to hold the device in position.

The fishing rod holders 15 are disposed on the interior of the ice fishing sled 30 and have a tubular construction. A fishing rod 31 can be positioned in a vertical orientation within the tubular fishing rod holder 15. The handle 32 of the fishing rod 31 extends through the bottom of the fishing rod holder 15, the reel 33 extends outward from the fishing rod holder 15 and passes through the channel thereon, and the rod extends upward from the upper end of the tubular fishing rod holder 15. In this way, multiple fishing rods can be held in an upright and easily accessible configuration, preventing damage from occurring to the fishing rods during travel.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A fishing equipment storage device, comprising:
an elongated panel having an upper end and a lower end;
one or more tubular fishing rod holders secured to a surface of said elongated panel;
at least one storage compartment secured to said surface of said elongated panel;
said upper end having a U-shaped lip adapted to be disposed over a support surface for securing said elongated panel thereto.

2. The fishing equipment storage device of claim 1, wherein said elongated panel is substantially rectangular in configuration.

3. The fishing equipment storage device of claim 1, wherein said one or more tubular fishing rod holders further includes a channel extending from an upper end of said tubular fishing rod holder toward a lower end thereof, such that a reel of a fishing rod can extend outward through said channel when said fishing rod is positioned within said fishing rod holder.

4. The fishing equipment storage device of claim 1, wherein said one or more tubular fishing rod holders are arranged in a side-by-side configuration.

5. The fishing equipment storage device of claim 1, wherein said at least one storage compartment comprise a bottom end, upstanding sidewalls, and an open upper end defining an interior volume.

6. The fishing equipment storage device of claim 5, wherein said at least one storage compartment further includes a lid pivotally secured to said open upper end by means of a hinge.

7. The fishing equipment storage device of claim 6, wherein said lid further includes a locking mechanism thereon.

8. The fishing equipment storage device of claim 1, wherein said U-shaped lip comprises a first section that is perpendicular to said panel and a second section that is turned downward and that is parallel to said panel.

9. The fishing equipment storage device of claim 1, wherein said U-shaped lip further includes one or more fasteners thereon for securing said elongated panel to a support surface by means of a frictional engagement.

10. The fishing equipment storage device of claim 9, wherein said one or more fasteners include thumbscrews.
